(19) United States
(12) Patent Application Publication
(10) Pub. No.: US 2003/0192046 A1
(43) Pub. Date: Oct. 9, 2003

(54) Transmission media, manipulation method and a device for manipulating the efficiency of a method for suppressing undesirable transmission blocks

(76) Inventor: Clemente Spehr, Munchen (DE)

Correspondence Address: Frank Chau, F Chau & Associates, Suite 501, 1900 Hempstead Turnpike, East Meadow, NY, 11554, US

(21) Appl. No.: 10/297,652

(22) PCT Filed: Jun. 7, 2001
(86) PCT No.: PCT/EP01/06469

(30) Foreign Application Priority Data
Jun. 9, 2000 (DE) 100286232

(51) Int. Cl. H04N 7/16; H04N 7/025; H04N 7/10

(52) U.S. Cl. 725/32; 725/25

(57) ABSTRACT

The invention relates to a method for manipulating the efficiency of technical methods for suppressing undesirable transmission blocks, for example blocks of advertisements. The significance of a suppression method of this type is artificially decreased by suppressing the aforementioned differentiating indicators during the transition between the programme part and the advertisement block, or artificially increased by inserting additional discrimination indicators into the playback of the desired transmission block.

### PRIOR ART

The present invention relates to a method and an apparatus for manipulation of the efficiency of a method for suppressing undesired transmission blocks, such as advertising blocks, in the reproduction of transmission media in entertainment electronics appliances or in computers, especially during television programs.

Although in principle undesired transmission blocks can be used in any transmission systems, the present invention and the problem on which it is based will be explained in more detail with reference to a stationary connected television, which has activated an apparatus for automatic suppression of undesired advertising blocks.

Methods for the suppression of advertising for entertainment electronics appliances are known, in particular for suppressing the reproduction of transmitted advertising blocks on stationary connected television and broadcast radio receivers.

The main object of such methods is to automatically identify the presence and the absence of an advertising block and to switch the television to another operating mode while the advertising block is being transmitted, for example to reduce the volume or to switch to a different program, etc., and to switch back to the same operating mode once again, as was present before the start of the advertising block, after the end of the advertising block.

In this case, with the progress in measures, a databank system which is set up for a centrally located service provider is used to identify the advertising blocks and makes use of a large number of features in order to distinguish between what is advertising and what is not advertising, with these features being included with individual weightings in an overall result of the evaluation process. This results in reliable criteria for identification of advertising. This overall result is then compared with a predetermined significance threshold for the presence of advertising. If the result is above this threshold, then the advertising block is suppressed, otherwise it is not.

It is furthermore known for an interface to be set up to an on-line service, in order to check the evaluation result of the service provider. The identification signal to be transmitted by the service provider can thus also be transmitted by cable to the final customer, in order to distinguish between what is advertising and what is not advertising.

It is also known for the presence and the absence of an advertising block to be identified automatically by evaluation of predetermined criteria, to be precise preferably with statistical assessment of the individual criteria. This results in an advertising block running signal and a complementary advertising block non-running signal for the analyzed transmission authorities and provides a so-called advertising box to the receiver, for example to the television viewer or radio listener, which can then suppress the reproduction of the advertising.

In particular, it is possible to switch the television or sound radio to a different operating mode during the time in which the advertising block is being transmitted, for example to reduce the volume or to switch to another program etc., and to switch back to the same operating mode, which was present before the start of the advertising block, once again after the end of the advertising block.

The methods described above are being increasingly developed further, and identify advertising to an ever better extent. All the advertising identification methods in this case operate on the same principle, namely in distinguishing between specific advertising overlays which define the advertising blocks and a currently running program. In addition to the above description, this can also be carried out manually, by operators.

However, advertising is a motor for the economy. Without advertising, certain services can be offered only at considerably greater prices than is the case with advertising. There is therefor a major financial requirement for a method which renders the advertising suppression mechanisms described above ineffective in order that advertising must nevertheless be seen. This also applies in a corresponding manner to radio advertising and to internet advertising and, in principle, to any media which are feasible but may not yet have been implemented.

No single method is known from the prior art for rendering such automatic methods for suppression of undesired transmission blocks ineffective, or at least for reducing their efficiency.

### ADVANTAGES OF THE INVENTION

The method according to the invention and having the features of claim 1 achieves this object.

According to the invention, precisely the same distinguishing features which the suppression methods evaluate are changed in or for transmission blocks which it is desired will be reproduced. In other words, the suppression methods are overridden by the same means which they themselves use in order to distinguish, for example, between advertising blocks and normal program parts. Features such as these are, in particular, features which can be identified in a technically simple manner in the program, such as the presence of stereo sound, the definition of a specific picture format, the presence of subtitles, a transmitter logo, an agent logo or a VPS signal etc.

The advertising suppression methods operate satisfactorily for the television consumers, radio consumers or internet users only if the significance of the transmission between a program part and an advertising block is identified correctly. Building on this, the present invention proposes that the significance of these programs be manipulated by varying one or more of the distinguishing features mentioned above when reproducing desired transmission blocks.

The dependent claims contain advantageous developments and improvements of the respective subject matter of the invention.

According to one preferred development of the present invention, the significance of such a suppression method is in this case artificially reduced in that the abovementioned distinguishing features during the transition between a program part and an advertising block are suppressed. This may be done in a wide range of ways, for example by means of morphing technologies, simple overlays or oscillating sections, in which there is no single transition between the program part and the advertising block, but in which the transmission is always switched alternately between the program and the advertising block during a certain transitional time between the program part and the advertising block so that the identification algorithm in the advertising block suppression program is “confused” and thus no longer operates.

According to a further preferred development, the distinguishing features are suppressed by using so-called morphing technologies. If in a situation such as this, for example a major star in the movie is located in front of a poster wall which is already displaying the following advertising block and is filling the format to an increasing extent, then it is virtually impossible to define the start of the advertising. Such material may also preferably comprise material cut from the movie production. Image processing may also be used, in the widest sense, in order to virtually “cutout” a major star from the movie that is currently being viewed and then to image it against an advertising background using so-called blue-box methods. The major star could likewise himself still remain present during the advertising and could himself make comments on the product being advertised. As can be seen from the measures described by way of example, there are a wide range of opportunities for use resulting from the abovementioned image processing/morphing technologies.

According to a further preferred development, certain distinguishing features, such as the transmitter logo, are already easily overlaid before the transition, and this likewise results in distinguishing features being suppressed. This possibility provides a further alternative independently of that mentioned above, and which can likewise be carried out in combination with one another.

According to a further preferred development, the identification of a transition is made more difficult by an oscillating reproduction change between desired and undesired transmission blocks. In this case, the time component of the undesired transmission block is preferably added to the undesired transmission block during the change from the desired transmission block and is deducted from it again during the opposite transition. The time intervals can be varied in a range below 1 second in a preferred manner in order that the viewer is not excessively irritated.

All the already mentioned measures may also be individualized—either individually or in conjunction with one another—by a random-superimposed configuration. This may preferably be achieved dynamically, for example controlled by the content of the currently transmitted transmission block. For example, the duration of an oscillating reproduction change, as has been described above, can be lengthened or shortened under random control, so that the viewer is not excessively disturbed although an advertising block suppression program does not actually find at least a constant time interval to which it can be set by the program. Other effective examples are feasible.

According to a further preferred development, which at the same time represents the second fundamental aspect of the present invention, the significance is deliberately increased by additionally inserting distinguishing features into the reproduction of the desired transmission block. The aim of this aspect is to change certain characteristics of the transmission in the ongoing program such that the advertising identification and suppression programs are initiated incorrectly without any advertising actually following. This undoubtedly has the consequence that the television viewer will miss a part of his movie owing to the advertising suppression program being switched on, which will undoubtedly cause a major proportion of television viewers to entirely stop using an advertising suppression program.

By way of example, the transmitter logo which is typically not displayed during the advertising block could be switched off during the desired program part or in general during the desired transmission blocks in order to simulate the presence of advertising. Measures such as these can also be generated dynamically in a preferred manner as a function of the technical characteristics of the currently transmitted, desired program part, for example the desired transmission block. Such deliberate simulation of distinguishing features may be carried out in a particular preferred manner in conjunction with a scene change during the television program or between two different pieces of music in a broadcast radio program. The individual technical features may in this case be chosen such that the viewer or the listener registers as little as possible of this. In this case as well, the method of inserting such “false” distinguishing features can be controlled via a random number generator, so that no system can be seen in this.

In addition, a wide range of combinations of distinguishing features can be inserted more or less at the same time.

Even the efficiency of high-quality suppression programs can be reduced considerably by individual measures or else by the sum of all the proposed measures, which can typically be combined at will. In principle, the proposed methods may even be applied to information streams or data streams which an end user receives via some network, for example via the Internet.

According to a further preferred development, the efficiency of different methods for suppressing undesired transmission blocks is stored and assessed, and the manipulation is optimized with computer assistance on the basis of the stored efficiencies, in order to improve the performance. This is self-learning feedback.

### DRAWINGS

Exemplary embodiments of the invention are illustrated in the drawings and will be explained in more detail in the following description.

In the figures:

FIG. 1 shows a schematic block diagram which illustrates the major components which are involved in one preferred exemplary embodiment of the method according to the invention;

FIG. 2 shows a flowchart which shows the major steps for suppression of the distinguishing features between a regular program part and an advertising block;

FIG. 3 shows a schematic illustration of the sequence of so-called advertising miniblocks and movie miniblocks, as are produced during the method shown in FIG. 2.

### DESCRIPTION OF THE EXEMPLARY EMBODIMENTS

Identical reference symbols in the figures denote the same or functionally identical components.

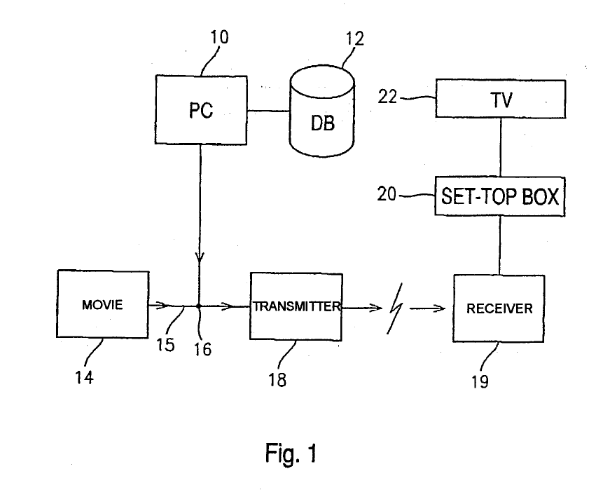

FIG. 1 shows a schematic block diagram which illustrates the major components for one preferred exemplary embodiment of the method according to the invention.

The transmission media manipulation method according to the present exemplary embodiment is in the form of a program which is installed on a conventional computer 10. The computer 10 is connected to a data bank 12, which preferably stores all the data which is expediently used for carrying out the present method, for example a collection of agent logos, a collection of product logos, etc. The PC 10 is linked to the databank 12 in the transmission authority for a television transmitter. A movie 14 is being transmitted at the moment. The movie signal—digital or analog—is passed through a cable 15 to the physical transmitting device 18. However, before it is transmitted, a signal produced by the PC 10 is superimposed on the signal and is fed at a logic point 16 into the signal for the movie, in an image processing step which is carried out digitally. In this way, by way of example, the transmitter logo may be fed in deliberately. Virtual advertising—for example an advertising logo in the center circle on a football field—or the like can equally be fed into an analog signal before (optional) conversion.

The transmission signal is then transmitted through the air or through a cable, is received by a receiver 19, and is then analyzed in a so-called set-top box 20 by an advertising suppression program which is available in the prior art, before being reproduced via the television 22. As can easily be seen from this outline sketch, the method according to the invention operates in the PC 10 on the advertising suppression program installed in the set-top box 20, in order to render this advertising suppression program as ineffective as possible.

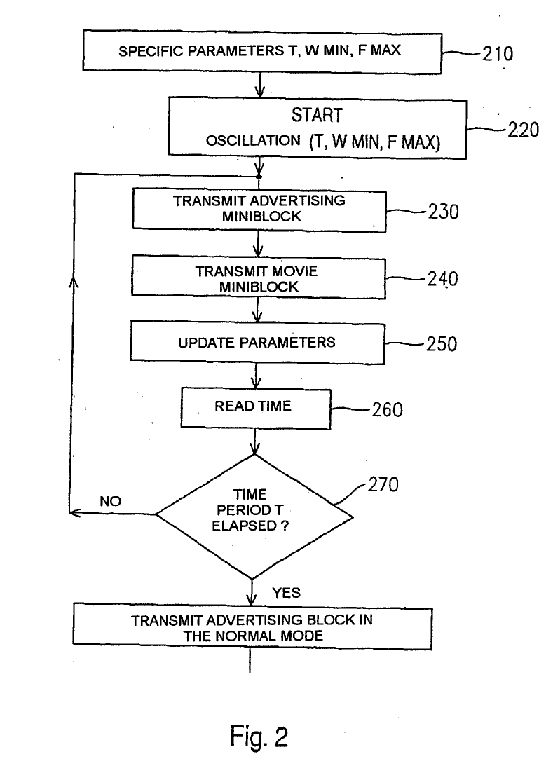

FIG. 2 shows a flow chart which shows the major steps for suppression of the distinguishing features between a regular desired program part and an undesired advertising block by means of an oscillating reproduction change.

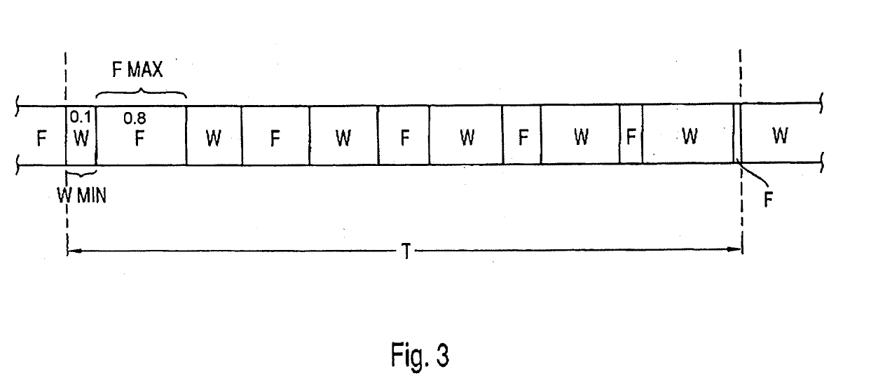

In FIG. 2, the parameters T, WMIN and FMAX are determined in a first step 210. The parameter T governs the overall duration within which an oscillating reproduction change occurs between a movie and an advertising block. FIG. 3 may be used at the same time for this purpose.

FIG. 3 shows a schematic illustration of the sequence of so-called advertising miniblocks and movie miniblocks, as are produced during the method shown in FIG. 2.

FIG. 3 shows a sequence of so-called miniblocks, with movie miniblocks F and advertising miniblocks W. These alternate in time in the transmitted stream. A block further on the right is shown after a block that is further on the left.

A regular movie is shown to the left of the sequence section, illustrated in FIG. 3, from the transmitted television signal, and a regular advertising block is indicated on the right. The transition between the movie and the advertising block is now completed within a time period which is indicated with T.

In step 210, T is defined to be 3 seconds, WMIN, the length of the shortest advertising miniblock, is defined to be 0.1 seconds, and FMAX is defined to be 0.8 seconds. FMAX is the time period of the longest movie miniblock during the oscillation phase.

The oscillation phase is then started in a step 220, since the program according to the invention has, for example via a real-time controller, identified that an advertising block will be transmitted in the near future. The oscillating alternation illustrated in FIG. 3 between the advertising miniblocks W and the movie miniblocks F is now produced in a loop which includes the steps 230 to 270. For this purpose the first advertising miniblock is transmitted with a length of 0.1 seconds in a step 230, as was established in the step 210. A movie miniblock is then transmitted, step 240, with the duration of 0.8 seconds, likewise as established in the step 210.

The parameters for transmitting the next advertising miniblock and movie miniblock pair are then determined. These are essentially the time periods for their transmission which must be calculated from new. The new calculation may preferably be carried out in accordance with a simple formula. For example, the duration of the advertising miniblocks may increase linearly, while the duration of the movie miniblocks decreases linearly. The illustration in FIG. 3 should be regarded as being only schematic in this case.

The time is then read, in step 260, in order to check whether the time interval T which was provided for the oscillating reproduction change has or has not already elapsed. This leads to a decision 270.

If the time has not yet elapsed, a jump is once again made up to the step 230, in order to send a new pair W, F with the newly calculated parameters.

The time interval T has elapsed after six runs through the loop, and the advertising block is shown uninterrupted in the normal mode, step 280.

According to the invention, the alternating sequence illustrated in FIG. 3 between a movie and advertising overrides the advertising suppression program, which is itself active in the set-top box 20 as shown in FIG. 1. Overall, the measure proposed in FIG. 2 produces a “soft” transition between the movie and the advertising block, during which the significance overall is so low that the start of the advertising block is not identified.

When the advertising block ends, no particular action need be carried out by the program according to the invention since its purpose has then already been satisfied. All that must be done is re-initialization, in order to ensure that the initial parameters are available once again for the transmission of the next advertising block.

Although the present invention has been described above on the basis of one preferred exemplary embodiment, it is not restricted to this, but can be modified in a wide range of ways.

For example, everything which has been described above can also be implemented in a separate window on only a part of the screen. The method may also be used for configuration of a transition between individual parts, that is to say between individual advertising spots in an advertising block as an undesired transmission block, in order to be equally effective in subsequent spots, as well.

The method is suitable not only for analog television but also for digital. All time periods and frequencies in or with which manipulation of the desired transmission block can take place may expediently be varied over a broad range, provided the end user can accept this.

1. A transmission media manipulation method for manipulation of the efficiency of a method for the suppression of undesired transmission blocks which, based on the evaluation of distinguishing features which can be predetermined in the transition between desired and undesired transmission blocks, carries out an identification of the transition and carries out the suppression,
characterized by the following step,
to manipulate the identification by changing one or more distinguishing features in the reproduction of desired transmission blocks.

2. The method as claimed in claim 1, with the method for suppressing undesired transmission blocks carrying out an identification of the significance and carrying out the suppression when the significance exceeds a significance threshold which can be predetermined.

3. The method as claimed in claim 1 or 2, in which the significance is reduced in that the distinguishing features are suppressed.

4. The method as claimed in the preceding claim, in which the identification of a transition between a desired and an undesired transmission block is made more difficult by morphing techniques.

5. The method as claimed in the preceding claim 1 or 2, in which the identification of a transition between a desired and an undesired transmission block is made more difficult by overlays of distinguishing features or overlays, in particular also of a geometric nature, of the complete transmission.

6. The method as claimed in the preceding claim 1, 2 or 3, in which individual objects in the transmission are exempted by means of an image processing device, in order to be available for overlays or superimpositions.

7. The method as claimed in the preceding claim 1 or 2, in which the identification of a transition between a desired and an undesired transmission block is made more difficult by an oscillating reproduction change between the two.

8. The method as claimed in one of the preceding claims 1 to 6, in which transitions between a desired and an undesired transmission block are individualized by a random-superimposed configuration.

9. The method as claimed in one of the preceding claims 1 to 7, used for configuration of a transition between individual parts of an undesired transmission block.

10. The method as claimed in claim 1, in which the significance is increased in that distinguishing features are additionally inserted into the reproduction of the desired transmission block.

11. The method as claimed in the preceding claim, in which combinations of distinguishing features are inserted.

12. The method as claimed in the preceding claim, in which individual images or a number of images or parts of them which contain undesired program parts are overlaid, in order to increase the significance during the evaluation of the distinguishing features which can be predetermined.

13. The method as claimed in the preceding claim, in which overlays are optimized deliberately over test series, in order to achieve a maximum significance increase with minimum viewer disturbance.

14. The method as claimed in the preceding claim 8 or 9, in which the combinations are produced by a random-number generator.

15. The method as claimed in one of the preceding claims, with parts of a television program, of a broadcast radio program or of an information stream which can be received via a network or via some other data transmission device being manipulated, in particular with regard to virtual advertising and split screen methods.

16. The method as claimed in one of the preceding claims 9 to 12, in which insertions are carried out at the same time as a scene change in a movie.

17. The method as claimed in one of the preceding claims, with at least one of the following features being evaluated as the distinguishing feature:
presence of stereo sound,
presence of two-channel sound,
presence of subtitles,
presence of a transmitter logo,
presence of an agent logo,
presence of a VPS signal,
change in the picture format
change to further technical features of the transmitted signal.

18. The method as claimed in one of the preceding claims, characterized in that the efficiency of different methods for suppressing undesired transmission blocks is stored and is assessed, and the manipulation is optimized with computer assistance on the basis of the stored efficiencies, in order to improve the performance.

19. A computer program containing code sections for computer-aided reproduction manipulation of media as claimed in one of the preceding claims.

20. A computer system, containing an installed program for carrying out the method as claimed in one of the preceding claims 1 to 14.
